(19) United States
(12) Patent Application Publication
(10) Pub. No.: US 2008/0052238 A1
(43) Pub. Date: Feb. 28, 2008

(54) SELECTABLE MARKET TRANSACTION OVER A NETWORK

(75) Inventor: Mark Nordlicht, New York, NY (US)

Correspondence Address: DARBY & DARBY P.C., P.O. BOX 770, Church Street Station, New York, NY, 10008-0770, US

(73) Assignee: Optionable, Inc., Valhalla, NY (US)

(21) Appl. No.: 11/932,535

(22) Filed: Oct. 31, 2007

Related U.S. Application Data
(62) Division of application No. 09/878,864, filed on Jun. 11, 2001.

(51) Int. Cl. H04L 9/00; G06Q 40/00

(52) U.S. Cl. 705/50; 705/37

(57) ABSTRACT

A trading network (102) composed of client devices (108, 110) and at least one clearinghouse device (104) associated with at least one exchange (106) and enables a transaction that is started on a first market type, such as a credit type market exchange to be concluded on a second market type, such as a clearing type market exchange.

### BACKGROUND OF THE INVENTION

1. Technical Field

The present invention relates to online electronic markets and, more particularly, to selecting the type of market for execution of a desired transaction over a network.

2. Related Art

Many types of markets exist for numerous types of items, including stocks, bonds, options, commodities, and collectables with the purpose of allowing buyers and sellers to trade their positions in a market. Some of the markets are more formally organized like the New York Mercantile Exchange, while others or less organized like Over-the-Counter markets.

The more formally organized markets commonly use a “clearing” type arrangement to settle trades that have occurred during a trading day. When a trade does occur, the clearinghouse is actually on both sides of the trade (buying from buyer and selling to seller). At the end of the day, one or more clearinghouses associated with an exchange settle the trades that have occurred and adjust the accounts of their members accordingly.

Each member of a clearinghouse has an account and is required to maintain a predetermined amount of liquidity in the account. If the liquidity drops below the predetermined amount, then the clearinghouse requires that member to deposit additional funds by issuing a cash call. Thus, the clearinghouse attempts to assure the liquidity of member accounts to cover member-trading activities.

In a less organized market, credit is used while trades are being conducted. The entities (people, companies, government agencies, etc. . . . ) involved in a trade agree upon the transaction and price. The transfer of the trade item(s) and money occur over an agreed time interval during which credit is being extended by the entity offering the item until the transaction is complete.

The entity that provides the item assumes the risk that the other entity involved in the trade is not credit worthy and will be unable to pay. Thus, the entity offering the item may decline to trade or deal with other entity that have dubious credit worthiness. Whereas, if the entities were trading on an exchange having a clearinghouse the credit worthiness of the other entity would not have been an impediment to the transaction.

The different markets are traditionally independent with no mechanism or process to switch a transaction, such as a credit exchange market transaction to a clearinghouse exchange market transaction. Any attempt to make such a switch greatly increases the time required to execute the transaction and thus introduce additional market fluctuation risk to the trading entities.

Thus, there is a need in the art for an order system that provides trading entities with the ability to change a transaction from a first market type to a second market type while introducing only a minimal delay into the trade executions.

### SUMMARY

The above problems are solved, and a number of technical advances are achieved in the art, by implementation of a system and method that provides entities with the ability to change transaction from a first market type to a second market type, such as from the clearinghouse exchange markets to the Over-the-Counter credit exchange markets. In particular, the present invention discloses a system and method for combining the first market type and the second market type electronically across a network. The system includes a computer network connected to a clearinghouse account system (clearinghouse device), and at least one trader client.

In a first implementation a seamless change from a first market type to a second market type occurs upon a predetermined condition not being met. A first entity is configured in a trading function to automatically attempt to complete the transaction on the second market type if predetermined conditions associated with the first market type is not met. An example of a predetermined condition not being met is a person who lacks credit worthiness attempting to accept an offer from the first entity over the first market type. The trading function determines that the credit worthiness of the person at the first client device. If the credit worthiness of the person on the other side of the trade does not met the predetermined condition, then the transaction is automatically switched to the second market type. Similarly, the trading function at the second entity may be configured rather than the trading function at the first entity, to automatically change from the first market type to the second market type when the acceptance of an offer from the first entity is declined for failing to meet the predetermined condition.

In another implementation, the first entity offers an item in a first market type exchange and the second entity attempts to accept the offer. If the trading function declines acceptance of the offer, due to a predetermined condition not being met (i.e. credit worthiness, prior trade history, affiliation of the first entity, etc. . . . ). The trading function then prompts the first entity to either reject the acceptance or change from the first market type to the second market type and complete the transaction on the second market type. Similarly, the trading function at the second entity may be configured, rather then the first entity, to be prompted to change from a first market type to a second market type upon the first entity rejection the acceptance.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a diagram of a network connecting a clearinghouse device and client devices in accordance with an embodiment of the invention;

FIG. 2 is a message flow diagram of a transaction between a first client device and a second client device involving different markets across the network of FIG. 1;

FIG. 3, is a message flow diagram of another embodiment of a transaction between a first client device and a second client device involving different markets across the network of FIG. 1;

FIG. 4 is a flow chart of the process steps of the first client device of FIG. 2 that is offering to trade; and

FIG. 5 is a flow chart of the process steps of the second client device of FIG. 2 accepting an offer to trade.

### DETAILED DESCRIPTION OF THE PREFERRED EMBODIMENT

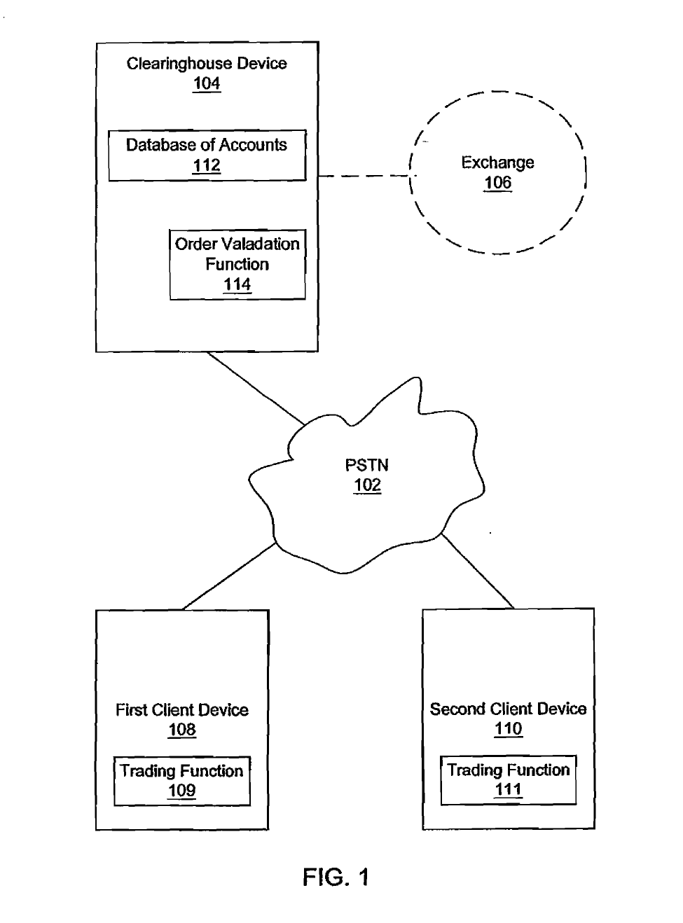

In FIG. 1, a diagram of a network 102 connecting a clearinghouse device 104 that is associated with an exchange 106, a first client device 108 and a second client device 110 that enable the trading of items, such as stocks, bonds, options, commodities, futures, and collectables is shown. The network 102 is a public telephone switching network (PSTN), but in other embodiments, the network 102 may selectively be any type of network (LAN, WAN, wireless, public, or private) or combination of networks capable of carrying or transmission of data; including X.25, cellular, SNA, TCP/IP, and Ethernet to name a few.

The clearinghouse device 104 is preferably a network server running a version of the UNIX operating system. Examples of such servers include Sun servers, IBM servers, and HP servers. In other embodiments, the servers may be a personal computer server, such as produced by Dell, Gateway, IBM, and Apple running Windows NT, UNIX, LINIX or MacOS operating system. The clearinghouse device 104 may be an independent server in the network or be paired to a redundant server in a hot/standby configuration.

The clearinghouse device 104 has access to account information contained in a database of accounts 112 that is in communication with an order validation function 114 that is associated with at least one exchange 106. The database of accounts 112 has a plurality of accounts with each account containing information about trades, balances, among other types of account data and are referred by an account identifier.

The database of accounts 112 may be present on the clearinghouse device 104 as shown in FIG. 1, or in alternate embodiments may be located on a separate database server or spread across multiple servers in a distributed database. Further, the order validation function 114 is shown operating on the clearinghouse device 104, but in an alternate embodiment the order validation function 114 may operate on a server separate from the clearinghouse device 104.

The first client device 108 and second client device 110 are personal computers with each having a memory and a processor, for example the Intel Pentium or Intel Celeron, running the windows operating system. In alternate embodiments the first client device 108 and second client device 110 may be IBM PCs or compatibles, Apple PCs, Personal Digital Assistants (PDAs) running windows CE or PalmOS operating systems, cellular phones, or any combination of the above. In yet another embodiment the first client device 108 and the second client device 110 may be telephonic devices (or a single telephonic device able to receive a plurality of calls) responding to telephone tone producing devices, such as a tone telephone. It is also contemplated that a first client device 108 and second client device 108 may be a dedicated device having a memory and an embedded controller functioning as the processor.

The first client device 108 and second client device 110 each have a trading function 109 and 111 respectively. The trading function, as shown in FIG. 1, is a set of machine readable instructions that are executed by the processor from the memory and have the ability to process clearinghouse information.

The trading function 109 and 111 are shown in FIG. 1 and are able to receive, transmit and process data from users. A user enters trade information at the first client device 108 and the machine readable instructions of the trading function 109 process the data and sends the data in the form of an offer. In an alternative embodiment, the machine readable instructions of the trading function 109 and 111 may be implemented in a markup language for execution by a web browser running on the first client device 108 and second client device 110. The data entered at the trading function 109 and 111 is transferred across the network 102 and processed by a web server.

An offer to sell or trade an item is made at the first client device 108 by entering trade information consisting of the number of items offered, item identifier and price into the trading function 109. The trading function 109 communicates across the network 102 with the second client device 110 in a first market type, such as a credit exchange market operating in a peer-to-peer trading environment or clearinghouse exchange market.

The second client device 110, executing trading function 111, which is similar to trading function 109, is made aware of the offered items and the user of the second client device 110 enters an acceptance to complete the trade. The first client device 108 may decline the acceptance of the trade because of predetermined condition has not been met, such as a low credit risk associated with the user controlling the second client device 110.

For example, the first client device 108 contains a list of trading partners that lack credit worthiness and a predetermined condition that credit trades only occur with trading partners who have credit worthiness. When the trading function 109 receives an acceptance from the other trading function 111, the acceptance contains a user identifier associated with that trader, for example a login id, registration code, address, driver license number, or identification code. The trading function 109 automatically checks the list of traders who lack credit worthiness.

If the user identifier associated with the trader at the second client device 110 is identified as lacking credit worthiness and not meeting the predetermined condition, then the trade with the second client device 110 in the first market type is rejected. In alternate embodiments, the predetermined conditions for determining whom to trade with includes information relating to federal regulations, employment association, or other definable conditions. In yet other embodiments, the predetermined conditions could be a negative condition that results in a rejected trade when the predetermined condition is met, such as a list of identifiers for people whom a trade on the first market type (credit exchange market in the current embodiment) trade would be accepted.

The rejection of the acceptance may be implemented in the trading function 109 as deal-by-deal with a user being prompted to reject the transaction at the first client device 108 or to be seamless and automatic. The first client device 108 receives the acceptance from the second client device 110. The trading function 109 at the first client device 108 then notifies the user that a trader lacking credit worthiness is attempting to accept the offer. The user at the first client device 108 is then prompted to either accept or reject the transaction in the first market type (credit exchange market).

Thus, first type transaction has been attempted and rejected. In an alternate embodiment, an Over-the-Counter server may provide the electronic trading web server with the first client device 108 and second client device 110 accessing the web server via the world wide web using a web browser executing web browser instructions (http, html, java, etc. . . . ).

Upon rejecting the acceptance of the second client device 110, a query is made to the second client device 110 asking if the user of the second client device 110 would like to complete the transaction using a second market type, such as a clearinghouse exchange market. The query message contains trade and clearinghouse account identification information associated with the first client device 108. The trade and clearinghouse account information associated with the first client device 108 is preferably encrypted and unreadable by the second client device 110.

If the second market type (a clearinghouse exchange market) is to be used, the clearinghouse account information associated with the user of the second client device 110, the account information from the first client device 108 and the trade information is formatted into a message and sent to the clearinghouse 104. The clearinghouse 104 then processes the account information in the order validation function 114. Thus, the transaction is changed from a first market type (credit exchange market) transaction to a second market type (clearinghouse exchange market) transaction based on a transaction-by-transaction determination and query of the second client device 110.

In an alternate embodiment, the trading function 109 on the second client device 110 is configured to change from the first market type transaction to a second market type transaction seamlessly and without prompting the user at the second client device 110. In other embodiments, the clearinghouse device 104 may contain trade information and account information relating to the first client device 108, requiring the second client device 110 to send only its clearinghouse account information.

The second client device 110 transmits the account number associated with the clearinghouse accounts to the order validation function 114 at the clearinghouse device 104. The order validation function 114 receives the message from the second client device 110 containing the trade information and the account numbers of the user located at the first client device 108 and the second client device 110 over the network 102. The order validation function 114 then communicates with the account database 112 containing the account information associated with the account numbers and updates the accounts to reflect the transaction. The order validation function 114 then notifies the first client device 108 and the second client device 110 of the completed transaction. Thus, resulting in the entities changing their transaction from a first market type (credit exchange market) transaction to a second market type (a clearinghouse exchange market transaction). The current embodiment is not limited to only one changing from the first market type to the second market type. Rather, the change may be made in either direction depending on the configuration of the trading functions 109 and 111.

In another embodiment, the first client device 108 communicates with the clearinghouse device 104 that has the account numbers received from the second client device 110 in an accept offer message. The account information from the second client device 110 contains an account identifier and a routing number associated with the clearinghouse device 104. When the first client device 108 receives an acceptance from the second client device 110 (either directly or indirectly through another server), it contains the account information associated with the user of the second client device 110. It is preferred that the account information associated with the user at the second client device 110 is sent in encrypted form and not accessible by the first client device 108.

Upon receipt of the acceptance, the first client device 108 determines if the user of the second client device 110 is in a list of user who lack credit worthiness. If the user of the second client device 110 is in such a list, the first client device 108 (either by prompting the first user or automatically) sends a message to the clearinghouse 104 containing information about the trade and account information associated with the first client device 108 and the second client device 110. Thus, resulting in the entities changing their transaction from the first market type (credit exchange market) transaction to the second market type (clearinghouse exchange market) transaction. The first trading function 109 is configured to automatically send the message to the clearinghouse 104 upon the predetermined condition of credit worthiness not being met, but in another embodiment, the trading function 109, may selectively be configured to generate a prompt for changing markets on a transaction-by-transaction basis.

The first client device 108 and second client device 110 can also verify the transaction has been completed by checking the account information located in the database of accounts 112 at the clearinghouse device 104. In an alternate embodiment, the order validation function 114 sends a message to the user at an email addresses accessible by the users of the first client device 108 and the second client device 110 respectively, informing the users to verify their account information.

The clearinghouse 104 is shown in the current embodiment as being on both sides of the trade. The clearinghouse 104 holds the funds in the account associated with the second client device 110 account number and often the items (i.e. 100 shares of stock) or security for the items that are being traded by the first client device 108. Thus, the credit risk assumed by the user of the first client device 108 is greatly reduced with the clearinghouse 104 on each side of the transaction. In an alternate embodiment, the clearinghouse 104 may be on only one side of the transaction and debit the account associated with the account number from the user of the second client device 110, while the items are sent from the user of the first client device 108 to the other user of the second client device 110. In yet another embodiment, two clearinghouses may communicate to complete a trade between the first client device 108 and the second client device 110.

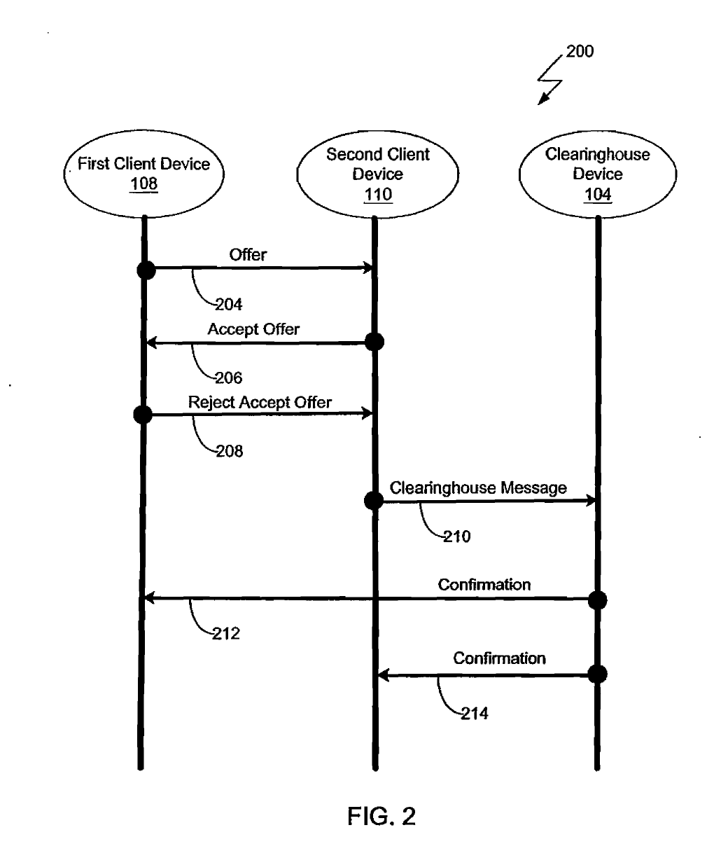

Turning to FIG. 2, a message flow diagram 200 of the transaction between the first client device 108 and the second client device 110 involving different markets across the network 102 of FIG. 1 is shown. The first client device 108 transmits an offer message 204 that is received at the second client device 110. The offer message 204 includes at least the number of items, item identifier, asking price, identifier of the user at the first client device 108, and a clearinghouse account identifier.

The second client device 108 sends an accept message 206 to the first client device 110. Upon receiving the accept message 206, the user at the first client device 108 must decide to complete the transaction or reject the acceptance received from the second client device 110. In the present embodiment, the user has been configured to change from the first market type (credit exchange market) to the second market type (clearinghouse exchange market) automatically, if the user of the second client device 110 appears on a list of user who lack credit worthiness.

If the first client device 108 rejects the trade acceptance, then a reject message 208 is sent to the second client device 110 containing clearinghouse account information associated with the user of the first client device 108. The reject message 208 contains a request to conduct the transaction over the clearinghouse exchange market rather than the credit exchange market. The second client device 110 is configured, to send a clearinghouse message 210, in order to accept the trade, to the clearinghouse 104. The clearinghouse message 210 that contains trading and account information associated with both the first client device 108 and the second client device 110.

In an alternate embodiment, the reject message 208 will trigger the second client device 110 to be prompted about changing markets. If the user at the second client device 110 desires to conduct the transaction over the clearinghouse exchange market, then the user at the second client device 110 causes the second client device 110 to send the clearinghouse message 210 that contains the clearinghouse account identifiers (routing, account numbers, and trade information) to the clearinghouse 104.

The clearinghouse 104 responds to the clearinghouse message 210 with a confirmation message 212 sent to the first client device 108 and a confirmation message 214 sent to the second client device 110. The confirmation messages 212 and 214 may indicate that the trade was successful or unsuccessful. In alternate embodiments, additional messages may be sent and received between the different devices and the message previously described messages may contain additional information.

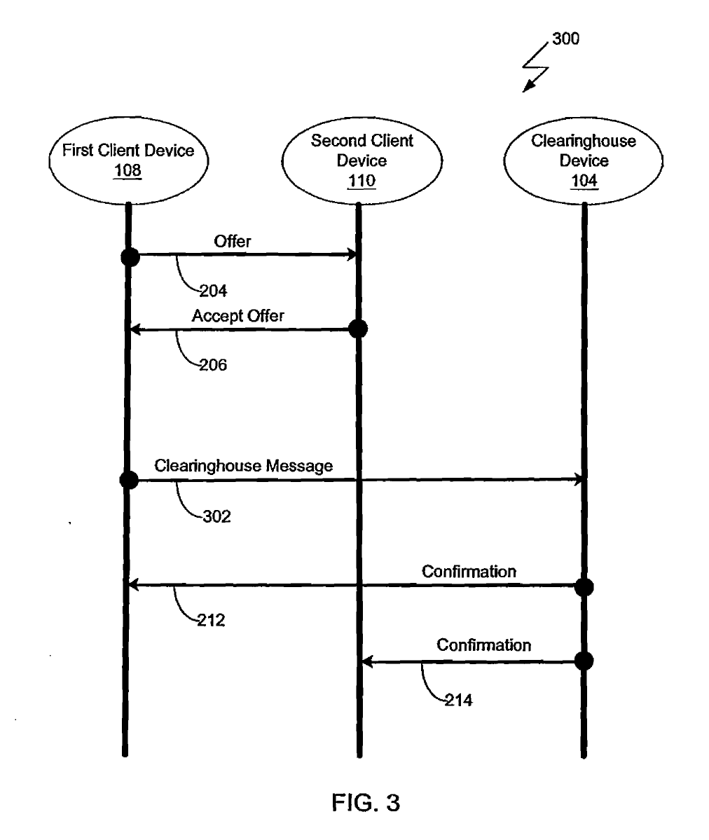

In FIG. 3, a message flow diagram 300 of the transaction between the first client device 108 and the second client device 110 involving different markets across the network 102 of FIG. 1 is shown. The first client device 108 sends an offer message 204 that is received by the second client device 110. The second client device 110 attempts to accept the offer by transmission of the accept offer message 206. The accept offer message 206, in this embodiment contains user information and clearinghouse account information associated with the user of the second client device 110.

Upon the first client device 108 receiving the accept message 210, a check of user who lack credit worthiness is conducted. If the user at the second client device 110 lacks credit worthiness, then the first client device 108 is preconfigured to send the clearinghouse message 302 to the clearinghouse device 104 for processing by the order validation function 114. The clearinghouse message 212 contains the trade information, routing information, and the account information associated with the first client device 108 and the second client device 110. The clearinghouse message 302 is processed by the order validation function 114 of the clearinghouse device 104. Upon processing of the clearinghouse message 302, the order validation function 114 sends a confirmation message 212 to the first client device 108 and another confirmation message 214 to the second client device 110. The confirmation message 212 and 214 indicate if the trade was successful or failed. In alternate embodiments, additional messages may be sent and received between the different devices and the message previously described messages may contain additional information.

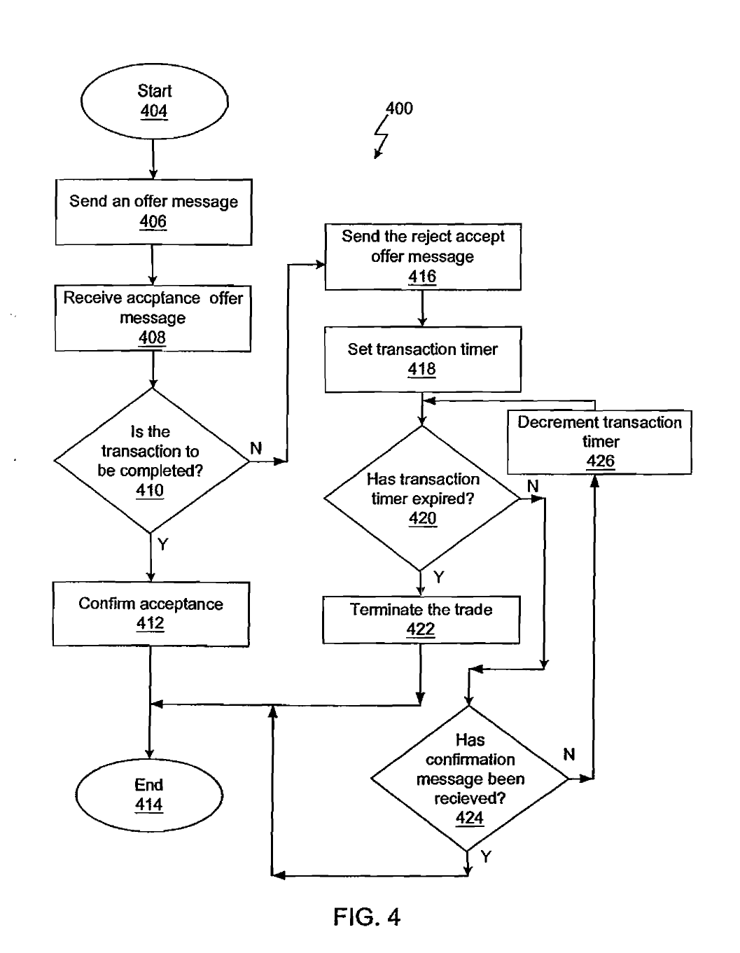

In FIG. 4, a flow chart 400 showing the process steps of a first client device 108 of FIG. 2 offering to trade an item. The process starts at step 404 when the first client device 108 sends an offer message 204, in step 406, to peers in a peer-to-peer network using a credit exchange market. In an alternate embodiment, the offer message is sent through a market server to other client devices. The process at the first client device 108 then waits to receive an acceptance. In step 408, the accept offer message 206 is received at the first client device 108 from the second client device 110. The first client device 108, in response to receiving the accept offer message 206, checks the list of users who lacks credit worthiness. If the user of the second client device 110 lacks credit worthiness, then in step 410 the user of the first client device 108 is prompted to identify if the transaction is to be completed or not as a credit exchange market transaction.

If the transaction is to be completed using the credit exchange market, then a confirmation of the acceptance, in step 412, is sent to the second client device 110 and processing is complete in step 414. If the first client device 108 in step 310 rejects the transaction, then in step 416, the first client device 108 sends a reject accept offer message 208 to the second client device 110.

In step 418, a transaction timer is set to a predetermined interval (two minutes in the present embodiment). The transaction timer set in step 418 is check to verify that it has not expired in step 420. If the transaction timer has expired in step 420, then the trade is terminated in step 422 and processing ends in step 414. If the transaction timer has not expired in step 420, then the first client device 108 makes a check to verify that the confirmation message 212 from the server device 104 has not been received.

If the confirmation message 212 has been received in step 424, then the trade or transaction is complete and processing ends in step 414. If the confirmation message 212 has not been received at the first client device 108, then in step 426, the transaction timer is decremented and step 420 is repeated.

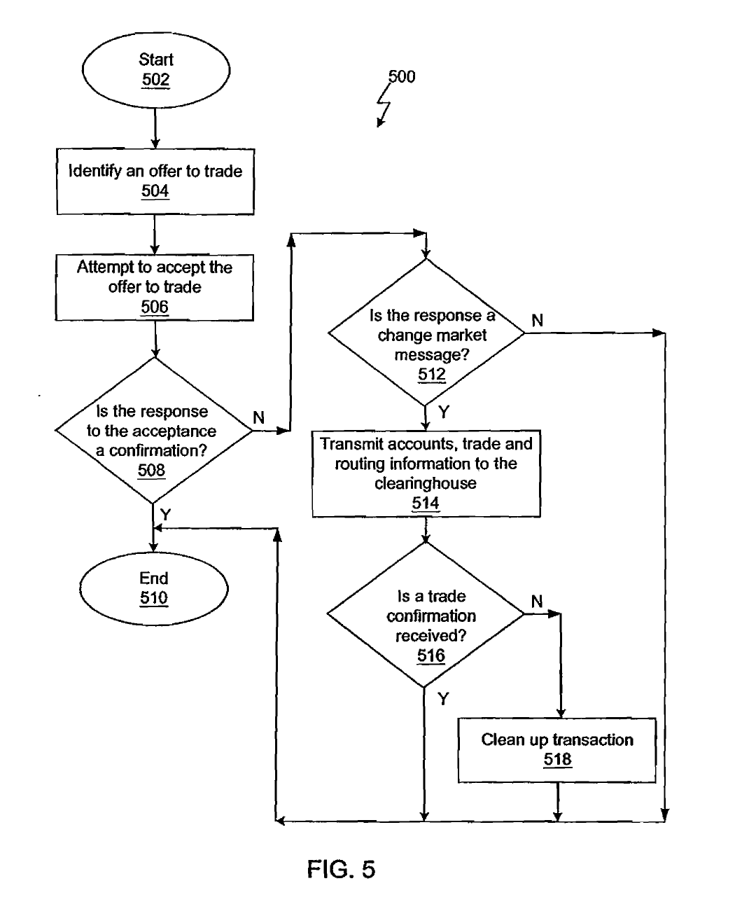

Referring to FIG. 5, a flow chart 500 of the process steps of the second client device 110 of FIG. 2 accepting an offer to trade is shown. The process starts at step 502 when an offer to trade has been identified at the second client device 110 that is occurring in a credit exchange market in step 504. The identification of an offer to trade in step 504 is by receiving an offer message 204 from the first client device 108. In other embodiments, the identification of an offer may be received from a server that is queried by the second client device 110. In step 506, an offer accept message 206 is sent from the second client device 110 to the first client device 108 in an attempt to accept the trade.

If in step 508, the response to step 506 is a trade confirmation message that confirms acceptance of the offer, then processing ends at step 510. If a trade confirmation message is not received at the second client device 110 in step 508, then a reject accept offer message 208 from the first client device 108 is checked for in step 512. The reject accept offer message 208 in step 512 is processed and a check is made to determine if clearinghouse account information associated with the user of the first client device 108 is present so the transaction can be conducted on a clearinghouse exchange market. If it is determined in step 512, that a clearinghouse exchange market transaction is to occur, then, in step 514, account information for both the first client device 108 and second client device 110, trade information and routing information is transmitted to the clearinghouse device 104. If the second client device 110 does not wish to change markets in step 512, then processing ends at step 510.

If the accounts, trading and routing information is sent in step 514 to the clearinghouse device 104, then the second client device 110 waits a predetermined period of time in step 516 for a confirmation message 214 from the server device 104. If a confirmation message 214 is received in step 516, then processing stops at step 510. If no confirmation message is received within the predetermined period of time in step 516, then in step 518, the transaction is ended and a cleanup of the transaction occurs after which processing stops in step 510.

It is appreciated by those skilled in the art that the process shown in FIG. 4 and FIG. 5 may selectively be implemented in hardware, software, or a combination of hardware and software. An embodiment of the process steps employs at least one machine-readable signal bearing medium. Examples of machine-readable signal bearing mediums include computer-readable mediums such as a magnetic storage medium (i.e. floppy disks, or optical storage such as compact disk (CD) or digital video disk (DVD)), a biological storage medium, or an atomic storage medium, a discrete logic circuit(s) having logic gates for implementing logic functions upon data signals, an application specific integrated circuit having appropriate logic gates, a programmable gate array(s) (PGA), a field programmable gate array (FPGA), a random access memory device (RAM), read only memory device (ROM), electronic programmable random access memory (EPROM), or equivalent. Note that the computer-readable medium could even be paper or another suitable medium, upon which the computer instructions are printed, as the program can be electronically captured, via for instance optical scanning of the paper or other medium, then compiled, interpreted or otherwise processed in a suitable manner if necessary, and then stored in a computer memory.

Additionally, machine-readable signal bearing medium includes computer-readable signal bearing mediums. Computer-readable signal bearing mediums have a modulated carrier signal transmitted over one or more wire based, wireless or fiber optic networks or within a system. For example, one or more wire based, wireless or fiber optic network, such as the telephone network, a local area network, the Internet, or a wireless network having a component of a computer-readable signal residing or passing through the network. The computer readable signal is a representation of one or more machine instructions written in or implemented with any number of programming languages.

Furthermore, the multiple process steps implemented with a programming language, which comprises an ordered listing of executable instructions for implementing logical functions, can be embodied in any machine-readable signal bearing medium for use by or in connection with an instruction execution system, apparatus, or device, such as a computer-based system, controller-containing system having a processor, microprocessor, digital signal processor, discrete logic circuit functioning as a controller, or other system that can fetch the instructions from the instruction execution system, apparatus, or device and execute the instructions.

1-28. (canceled)

29. A method for facilitating transactions, comprising the steps of:
receiving, at a first client device, an accept offer message for a transaction to occur, said transaction being of a first market type, and having a second account identifier associated with a second client device;
rejecting the transaction at the first client device;
transmitting the second account identifier and a first account identifier associated with the first client device from the first client device to a clearinghouse device; and
receiving, at the first client device, a confirmation that the transaction occurred as a second market type.

30. The method of claim 29, wherein the first market type is a clearinghouse exchange market.

31. The method of claim 29, wherein the first market type is a credit exchange market.

32-40. (canceled)

41. The method of claim 29, further comprising the step of encrypting the second account identifier at the second client device prior to transmission to the first client device.

42. The method of claim 29, further comprising the step of encrypting the first account identifier at the first client device.

43. The method of claim 29, further comprising the step of generating a user prompt in response to rejection of the transaction of the first market type that identifies the transaction can occur as the second market type.

44-45. (canceled)

46. A method of changing a transaction from a first market type to a second market type, comprising the steps of:
at a first client device connected to a network, transmitting an offer to conduct the transaction that is received by at least a second client device connected to the network;
at the second client device, transmitting an acceptance of the offer to conduct the transaction;
determining whether first and second predetermined conditions are met; and
automatically changing the transaction from the first market type to the second market type when the first and second predetermined conditions are met.

47-52. (canceled)

53. The method of claim 46, wherein the first predetermined condition is based on the identities of entities participating in the transaction, and the second predetermined condition is based on terms of the transaction.
